(19) United States
(12) Patent Application Publication
(10) Pub. No.: US 2025/0350527 A1
(43) Pub. Date: Nov. 13, 2025

(54) CONFIGURATION MANAGEMENT METHOD AND APPARATUS, DEVICE AND STORAGE MEDIUM

(71) Applicant: BEIJING XIAOMI MOBILE SOFTWARE CO., LTD., Beijing (CN)

(72) Inventors: Yumin WU, Beijing (CN); Yi XIONG, Beijing (CN)

(73) Assignee: BEIJING XIAOMI MOBILE SOFTWARE CO., LTD., Beijing (CN)

(21) Appl. No.: 18/861,435

(22) PCT Filed: Apr. 29, 2022
(86) PCT No.: PCT/CN2022/090783

§ 371 Date: Oct. 29, 2024

(51) Int. Cl. H04L 41/0631; H04L 41/08

(52) U.S. Cl. CPC H04L 41/065; H04L 41/0876

(57) ABSTRACT

A configuration management method performed by a network-side device includes: configuring a candidate cell or cell group for a terminal device; and determining a configuration mode corresponding to configuration information of the candidate cell or cell group.

### TECHNICAL FIELD

This disclosure relates to the field of communication technology, and in particular, to a method, an apparatus, a device and a storage medium for managing configuration.

### BACKGROUND

In network communication technology, network-side devices can provide preconfigured cells or cell groups to terminal devices, where configuration information of the preconfigured cells or cell groups can be configured by means of full configuration or delta configuration. Accordingly, in order to enable the terminal device to perform terminal configuration according to a configuration mode corresponding to the configuration information of the preconfigured cells or cell groups, how to stipulate the configuration behavior of the terminal device and the network-side device is an issue that needs to be solved urgently.

### SUMMARY

According to the method, apparatus, device and storage medium for managing configuration proposed by this disclosure, the configuration behavior of the terminal device and the network-side device can be stipulated, so that consistent understanding of the configuration information and configuration mode of the preconfigured cell or cell group can be maintained between the terminal device and the network-side device.

A first aspect of embodiments of this disclosure provides a configuration management method, which is performed by a network-side device and includes: configuring one or more candidate cells or cell groups for a terminal device; and determining a configuration mode corresponding to configuration information of at least part of the one or more candidate cells or cell groups.

Optionally, in an embodiment of this disclosure, the configuration mode includes at least one of a full configuration mode and a delta configuration mode.

Optionally, in an embodiment of this disclosure, the method further includes: determining, in case the configuration mode being the delta configuration mode, reference configuration information corresponding to the delta configuration mode, where the reference configuration information is configuration information of a specific cell or a specific cell group.

Optionally, in an embodiment of this disclosure, the reference configuration information includes any one of:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

Optionally, in an embodiment of this disclosure, a type of the candidate cell or cell group after activation is determined according to network configuration or protocol agreement.

Optionally, in an embodiment of this disclosure, the type of the candidate cell after activation is any one of a primary cell, a primary secondary cell, a special cell, a secondary cell, a secondary cell in a master cell group, and a secondary cell in a secondary cell group.

Optionally, in an embodiment of this disclosure, the type of the candidate cell group after activation is a master cell group or a secondary cell group.

Optionally, in an embodiment of this disclosure, determining the configuration mode corresponding to the configuration information of the at least part of the one or more candidate cells or cell groups includes:

indicating that the configuration mode corresponding to the configuration information of the at least part of the one or more candidate cells or cell groups is the full configuration mode or the delta configuration mode; or indicating that the configuration mode corresponding to the configuration information of the at least part of the one or more candidate cells or cell groups is not the full configuration mode or is not the delta configuration mode.

A second aspect of embodiments of this disclosure provides a configuration management method, which is performed by a terminal device and includes:
receiving configuration information of one or more candidate cells or cell groups, and a configuration mode corresponding to configuration information of at least part of the one or more candidate cells or cell groups; and
configuring the terminal device according to the configuration mode corresponding to the configuration information of the one or more candidate cells or cell groups.

Optionally, in an embodiment of this disclosure, the configuration mode includes at least one of a full configuration mode and a delta configuration mode.

Optionally, in an embodiment of this disclosure, in case the configuration mode being the delta configuration mode, performing the configuration according to the configuration mode corresponding to the configuration information of the one or more candidate cells or cell groups includes:

configuring the terminal device according to the configuration information and reference configuration information corresponding to the delta configuration mode, where the reference configuration information is configuration information of a specific cell or a specific cell group.

Optionally, in an embodiment of this disclosure, the reference configuration information includes any one of:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

Optionally, in an embodiment of this disclosure, a type of the candidate cell or cell group after activation is determined according to network configuration or protocol agreement.

Optionally, in an embodiment of this disclosure, the type of the candidate cell after activation is any one of a primary cell, a primary secondary cell, a special cell, a secondary cell, a secondary cell in a master cell group, and a secondary cell in a secondary cell group.

Optionally, in an embodiment of this disclosure, the type of the candidate cell group after activation is a master cell group or a secondary cell group.

Optionally, in an embodiment of this disclosure, the method further includes:
storing the configuration information of the one or more candidate cells or cell groups according to the configuration mode.

Optionally, in an embodiment of this disclosure, storing the configuration information of the one or more candidate cells or cell groups according to the configuration mode includes:
storing, in case the configuration mode being a full configuration mode, the configuration information of the one or more candidate cells or cell groups; and
merging, in case the configuration mode being a delta configuration mode, reference configuration information and the configuration information of the one or more candidate cells or cell groups for storage.

A third aspect of embodiments of this disclosure provides a configuration management method, which is performed by a source node and includes:
determining reference configuration information; and
sending the reference configuration information to a target node.

Optionally, in an embodiment of this disclosure, the method further includes:
indicating a type of cell or cell group corresponding to the reference configuration information.

Optionally, in an embodiment of this disclosure, the reference configuration information is configuration information of a specific cell or a specific cell group.

Optionally, in an embodiment of this disclosure, the type of cell or cell group corresponding to the reference configuration information is the same as a type of the candidate cell or cell group.

Optionally, in an embodiment of this disclosure, the type of cell is any one of a primary cell, a primary secondary cell, a special cell, a secondary cell, a secondary cell in a master cell group, and a secondary cell in a secondary cell group.

Optionally, in an embodiment of this disclosure, the type of cell group is a master cell group or a secondary cell group.

A fourth aspect of embodiments of this disclosure provides a configuration management method, which is performed by a target node and includes:
sending configuration information of a candidate cell or cell group to a source node; and indicating a configuration mode corresponding to the configuration information of the candidate cell or cell group.

Optionally, in an embodiment of this disclosure, the configuration mode includes at least one of a full configuration mode and a delta configuration mode.

Optionally, in an embodiment of this disclosure, the method further includes:

indicating, in case the configuration mode being the delta configuration mode, reference configuration information corresponding to the candidate cell or cell group.

Another aspect of embodiments of this disclosure provides a configuration management apparatus, including:
a configuring module, adapted to configure one or more candidate cells or cell groups for a terminal device; and
a determining module, adapted to determine a configuration mode corresponding to configuration information of at least part of the one or more candidate cells or cell groups.

Another aspect of embodiments of this disclosure provides a configuration management apparatus, including:
a receiving module, adapted to receive configuration information of one or more candidate cells or cell groups, and a configuration mode corresponding to configuration information of at least part of the one or more candidate cells or cell groups; and
a configuring module, adapted to configure a terminal device according to the configuration mode corresponding to the configuration information of the one or more candidate cells or cell groups.

Another aspect of embodiments of this disclosure provides a configuration management apparatus, including:
a determining module, adapted to determine reference configuration information; and
a sending module, adapted to send the reference configuration information to a target node.

Another aspect of embodiments of this disclosure provides a configuration management apparatus, including:
a sending module, adapted to send configuration information of a candidate cell or cell group to a source node; and
an indicating module, adapted to indicate a configuration mode corresponding to the configuration information of the candidate cell or cell group.

Another aspect of embodiments of this disclosure provides a communication device including a processor and a memory, where the memory stores a computer program, and the processor is configured to, upon executing the computer program stored in the memory, causes the device to implement the method according to the above first aspect of embodiments.

Another aspect of embodiments of this disclosure provides a communication device including a processor and a memory, where the memory stores a computer program, and the processor is configured to, upon executing the computer program stored in the memory, causes the device to implement the method according to the above second aspect of embodiments.

Another aspect of embodiments of this disclosure provides a communication device including a processor and a memory, where the memory stores a computer program, and the processor is configured to, upon executing the computer program stored in the memory, causes the device to implement the method according to the above third aspect of embodiments.

Another aspect of embodiments of this disclosure provides a communication device including a processor and a memory, where the memory stores a computer program, and the processor is configured to, upon executing the computer program stored in the memory, causes the device to implement the method according to the above fourth aspect of embodiments.

Another aspect of embodiments of this disclosure provides a communication device, including a processor and an interface circuit, the interface circuit is configured to receive a code instruction and transmit the code instruction to the processor; and the processor is configured to, upon running the code instruction, implement the method according to the above first aspect of embodiments.

Another aspect of embodiments of this disclosure provides a communication device, including a processor and an interface circuit,
the interface circuit is configured to receive a code instruction and transmit the code instruction to the processor; and
the processor is configured to, upon running the code instruction, implement the method according to the above second aspect of embodiments.

Another aspect of embodiments of this disclosure provides a communication device, including a processor and an interface circuit,
the interface circuit is configured to receive a code instruction and transmit the code instruction to the processor; and
the processor is configured to, upon running the code instruction, implement the method according to the above third aspect of embodiments.

Another aspect of embodiments of this disclosure provides a communication device, including a processor and an interface circuit,
the interface circuit is configured to receive a code instruction and transmit the code instruction to the processor; and
the processor is configured to, upon running the code instruction, implement the method according to the above fourth aspect of embodiments.

Another aspect of embodiments of this disclosure provides a computer readable storage medium, configured to store an instruction, where the instruction, upon being executed, cause the method according to the above first aspect of embodiments to be implemented.

Another aspect of embodiments of this disclosure provides a computer readable storage medium, configured to store an instruction, where the instruction, upon being executed, cause the method according to the above second aspect of embodiments to be implemented.

Another aspect of embodiments of this disclosure provides a computer readable storage medium, configured to store an instruction, where the instruction, upon being executed, cause the method according to the above third aspect of embodiments to be implemented.

Another aspect of embodiments of this disclosure provides a computer readable storage medium, configured to store an instruction, where the instruction, upon being executed, cause the method according to the above fourth aspect of embodiments to be implemented.

To sum up, according to the method, apparatus, device and storage medium for managing configuration proposed by this disclosure, the network-side device configures one or more candidate cells or cell groups for the terminal device; and determines a configuration mode corresponding to configuration information of at least part of the one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

### BRIEF DESCRIPTION OF THE DRAWINGS

The above and/or additional aspects and advantages of this disclosure will become apparent and readily understood from the following description of the embodiments in conjunction with the accompanying drawings, in which:

FIG. 1 is a schematic flowchart of a configuration management method according to an embodiment of this disclosure;

FIG. 2 is a schematic flowchart of a configuration management method according to another embodiment of this disclosure;

FIG. 3 is a schematic flowchart of a configuration management method according to another embodiment of this disclosure;

FIG. 4 is a schematic flowchart of a configuration management method according to another embodiment of this disclosure;

FIG. 5 is a schematic flowchart of a configuration management method according to another embodiment of this disclosure;

FIG. 6 is a schematic flowchart of a configuration management method according to another embodiment of this disclosure;

FIG. 7 is a schematic flowchart of a configuration management method according to another embodiment of this disclosure;

FIG. 8 is a schematic flowchart of a configuration management method according to another embodiment of this disclosure;

FIG. 9 is a schematic flowchart of a configuration management method according to another embodiment of this disclosure;

FIG. 10 is a schematic flowchart of a configuration management method according to another embodiment of this disclosure;

FIG. 11 is a schematic flowchart of a configuration management method according to another embodiment of this disclosure;

FIG. 12 is a schematic structural diagram of a configuration management apparatus according to an embodiment of this disclosure;

FIG. 13 is a schematic structural diagram of a configuration management apparatus according to another embodiment of this disclosure;

FIG. 14 is a schematic structural diagram of a configuration management apparatus according to another embodiment of this disclosure;

FIG. 15 is a schematic structural diagram of a configuration management apparatus according to another embodiment of this disclosure;

FIG. 16 is a block diagram of a terminal device according to an embodiment of this disclosure; and

FIG. 17 is a block diagram of a network-side device according to an embodiment of this disclosure.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments do not represent all implementations consistent with embodiments of this disclosure. Rather, they are merely examples of apparatus and methods consistent with aspects of embodiments of this disclosure as detailed in the appended claims.

The terminology used in the embodiments of this disclosure is for the purpose of describing specific embodiments only and is not intended to limit the embodiments of this disclosure. As used in the embodiments of this disclosure and the appended claims, the singular forms “a/an” and “the” are intended to include the plural forms as well, unless the context clearly dictates otherwise. It will also be understood that the term “and/or” as used herein refers to and includes any and all possible combinations of one or more of the associated listed items.

It should be understood that although the terms first, second, third, etc. may be used to describe various information in the embodiments of this disclosure, the information should not be limited to these terms. These terms are only used to distinguish information of the same type from each other. For example, without departing from the scope of the embodiments of this disclosure, the first information may also be called second information, and similarly, the second information may also be called first information. Depending on the context, the words “if” and “in case” as used herein may be interpreted as “when” or “while” or “in response to determining.”

The method, apparatus, device and storage medium for managing configuration according to embodiments of this disclosure will be described in detail below with reference to the accompanying drawings.

FIG. 1 is a schematic flowchart of a configuration management method according to an embodiment of this disclosure. The method is performed by a network-side device. As shown in FIG. 1, the method may include the following steps.

In step 101, one or more candidate cells or cell groups are configured for a terminal device.

For example, the network-side device may be a base station, which may send configuration information of one or more candidate cells or cell groups to the terminal device, and a configuration mode corresponding to the configuration information of the one or more candidate cells or cell groups.

It should be noted that, in an embodiment of this disclosure, the terminal device (User Equipment, UE) may be a device that provides voice and/or data connectivity to users. Terminal devices can communicate with one or more core networks via RAN (Radio Access Network). UEs can be IoT terminals, such as sensor devices, mobile phones (or “cellular” phones) and computers provided with IoT terminals. For example, UE may be a fixed, portable, pocket-sized, handheld, built-in computer or vehicle-mounted, such as station (STA), subscriber unit, subscriber station, mobile station, mobile, remote station, access point, remote terminal, access terminal, user terminal or user agent. Alternatively, UE may also be a device of an unmanned aerial vehicle. Alternatively, UE may also be a vehicle-mounted device, such as a driving computer with a wireless communication function, or a wireless terminal connected to an external driving computer. Alternatively, UE may also be a roadside device, such as a streetlight, a signal light, or other roadside device with wireless communication functions.

In step 102, a configuration mode corresponding to configuration information of at least part of the one or more candidate cells or cell groups is determined.

In an embodiment of this disclosure, the configuration mode may include at least one of a full configuration mode and a delta configuration mode.

It should be noted that in 4G (the 4th generation mobile communication technology) and 5G (the 5th Generation Mobile Communication Technology) systems, the network-side device provides the terminal device with RRC (Radio Resource Control) configuration information for configuring the air interface communication of the terminal. The RRC configuration information can be configured in two modes: full configuration and delta configuration.

The full configuration mode means, upon receiving a new RRC configuration message in the full configuration mode, clearing the current radio configuration (e.g., dedicated radio configuration and general radio configuration), and then applying the RRC configuration message in the full configuration mode.

The delta configuration mode means, upon receiving a new RRC configuration message in the delta configuration mode, applying the configuration in the RRC configuration message in the delta configuration mode based on the current radio configuration. The “current radio configuration” is considered as the “reference configuration” for the “delta configuration”. (For example, a value of “field-1” in the current radio configuration is “1”, a value of “field-2” therein is “1”, and a value of “field-1” in the delta configuration is “2”; after receiving the delta configuration, the value of “field-1″ is set to “2” and the value of “field-2” remains as “1”).

To sum up, according to the method, apparatus, device and storage medium for managing configuration proposed by this disclosure, the network-side device configures one or more candidate cells or cell groups for the terminal device; and determines a configuration mode corresponding to configuration information of at least part of the one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

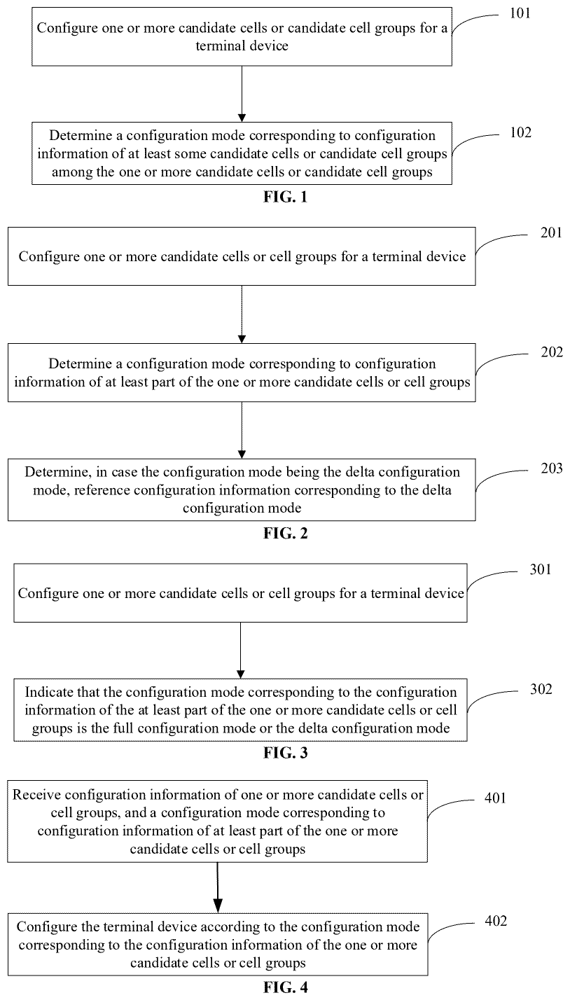

FIG. 2 is a schematic flowchart of a configuration management method according to an embodiment of this disclosure. The method is performed by a network-side device. As shown in FIG. 2, the method may include the following steps.

In step 201, one or more candidate cells or cell groups are configured for the terminal device.

In step 202, a configuration mode corresponding to configuration information of at least part of the one or more candidate cells or cell groups is determined.

In step 203, when the configuration mode is the delta configuration mode, reference configuration information corresponding to the delta configuration mode is determined.

The reference configuration information may be configuration information of a specific cell or a specific cell group.

Further, in an embodiment of this disclosure, the reference configuration information may include any of the following:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

Further, in an embodiment of this disclosure, a type of the candidate cell or cell group after activation is determined according to network configuration or protocol agreement.

It should be noted that when the delta configuration mode is adopted, the reference configuration information corresponding to the delta configuration mode, that is, the configuration information of the candidate cell or candidate cell group is the delta configuration information relative to which reference configuration information, can be determined through network configuration or protocol agreement. Herein, the reference configuration information may include any of the following types.

As to reference configuration information 1, for specific “configuration information of a candidate cell or cell group” in the delta configuration mode, the “reference configuration information” is “configuration information of a cell or cell group” designated by the network-side device. For example, “candidate cell group configuration-1” is the “delta configuration information” of “candidate cell group configuration-2”, and “candidate cell group configuration-2” is the “reference configuration information” of “candidate cell group configuration-1”. For example, “candidate cell group configuration-1” is the “delta configuration information” of “configuration information of a currently serving (or activated) MCG (or SCG)”, and the “configuration information of the currently serving (or activated) MCG (or SCG)” is the “reference configuration information” of “candidate cell group configuration-1”.

As to reference configuration information 2, for specific “configuration information of a candidate cell or cell group” in the delta configuration mode, “configuration information of a currently serving (or activated) cell or cell group” having a same type as a “candidate cell or cell group type” when it is activated serves as the “reference configuration information” thereof. For example, “candidate cell group configuration-1” is in the “delta configuration mode”, and “candidate cell group configuration-1” is MCG (or SCG) after activation; when the terminal device triggers the activation of “candidate cell group configuration-1” (e.g., when an activation command issued by the network side is received), the “configuration information of a currently serving (or activated) MCG (or SCG)” is the “reference configuration information” of “candidate cell group configuration-1”.

As to reference configuration information 3, for a specific “configuration information of a candidate cell or cell group” in the delta configuration mode, “configuration information of a currently serving (or activated) cell or cell group” having a same type as a “candidate cell or cell group type” when it is activated for the first time serves as the “reference configuration information” thereof. For example, “candidate cell group configuration-1” is in the “delta configuration mode”, and “candidate cell group configuration-1” is MCG (or SCG) after activation; after the terminal device receives “candidate cell group configuration-1”, when the terminal triggers the activation of “candidate cell group configuration-1” for the first time (e.g., when it receives a command to activate “candidate cell group configuration-1” issued by the network side for the first time), then the “configuration information of a currently serving (or activated) MCG (or SCG)” is the “reference configuration information” of “candidate cell group configuration-1”.

As to reference configuration information 4, for a specific “configuration information of a candidate cell or cell group” sent in the delta configuration, “configuration information of a serving (or activated) cell or cell group”, upon receiving the “configuration information of a candidate cell or cell group”, having a same type as a “cell or cell group type” after activation, serves as the “reference configuration information” thereof. For example, “candidate cell group configuration-1” is in the “delta configuration mode”, “candidate cell group configuration-1” is MCG (or SCG) after activation, and a sending (or receiving) timepoint of “candidate cell group configuration-1” is t1, then “configuration information of a serving (or activated) MCG (or SCG) at t1” is the “reference configuration information” of “candidate cell group configuration-1”.

Further, in an embodiment of this disclosure, the type of the candidate cell after activation is any one of a primary cell, a primary secondary cell, a special cell, a secondary cell, a secondary cell in a master cell group, and a secondary cell in a secondary cell group.

Further, in an embodiment of this disclosure, the type of the candidate cell group after activation is a master cell group or a secondary cell group.

It should be noted that due to the adoption of dual connectivity (DC) architecture in the 5G system, it includes the following two cell groups:
MCG (Master Cell Group): corresponding to the network-side MN (Master Node);
SCG (Secondary Cell Group): corresponding to the network-side SN (Secondary Node).

Herein, MCG may include a PCell (Primary Cell) and one or more SCells (Secondary Cell); SCG may include a PSCell (Primary Secondary Cell) and one or more SCells, where PCell and PSCell may be collectively referred to as SpCell (Special Cell).

To sum up, according to the method, apparatus, device and storage medium for managing configuration proposed by this disclosure, the network-side device configures one or more candidate cells or cell groups for the terminal device; and determines a configuration mode corresponding to configuration information of at least part of the one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

FIG. 3 is a schematic flowchart of a configuration management method according to an embodiment of this disclosure. The method is performed by a network-side device. As shown in FIG. 2, the method may include the following steps.

In step 301, one or more candidate cells or cell groups are configured for the terminal device.

In step 302, a configuration mode corresponding to configuration information of at least part of the one or more candidate cells or cell groups is indicated as a full configuration mode or a delta configuration mode.

Alternatively, the configuration mode corresponding to the configuration information of at least part of the one or more candidate cells or cell groups is indicated as being not the full configuration mode or being not the delta configuration mode.

It should be noted that the configuration mode indication method can include any of the followings.

In an indication manner 1, the use of “delta configuration mode” or “full configuration mode” is indicated. (For example, 1 bit is used, the value “0” represents “delta configuration mode”, and the value “1” represents “full configuration mode”.)

In an indication manner 2, when the “full configuration mode” is not indicated, the “delta configuration mode” is used by default.

In an indication manner 3, when the “delta configuration mode” is not indicated, the “full configuration mode” is used by default.

In an indication manner 3, when there is not any indication, the “delta configuration mode” is used by default. The indication information indicates whether to adopt the “full configuration mode”.

To sum up, according to the method, apparatus, device and storage medium for managing configuration proposed by this disclosure, the network-side device configures one or more candidate cells or cell groups for the terminal device; and determines a configuration mode corresponding to configuration information of at least part of the one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

FIG. 4 is a schematic flowchart of a configuration management method according to an embodiment of this disclosure. The method is performed by a terminal device. As shown in FIG. 4, the method may include the following steps.

In step 401, configuration information of one or more candidate cells or cell groups, and a configuration mode corresponding to configuration information of at least part of the one or more candidate cells or cell groups, are received.

In step 402, the terminal device is configured according to the configuration mode corresponding to the configuration information of one or more candidate cells or cell groups.

For example, in an embodiment of this disclosure, the terminal device (UE) may be a device that provides voice and/or data connectivity to users. Terminal devices can communicate with one or more core networks via RAN. UEs can be IoT terminals, such as sensor devices, mobile phones (or “cellular” phones) and computers provided with IoT terminals. For example, UE may be a fixed, portable, pocket-sized, handheld, built-in computer or vehicle-mounted, such as station (STA), subscriber unit, subscriber station, mobile station, mobile, remote station, access point, remote terminal, access terminal, user terminal or user agent. Alternatively, UE may also be a device of an unmanned aerial vehicle. Alternatively, UE may also be a vehicle-mounted device, such as a driving computer with a wireless communication function, or a wireless terminal connected to an external driving computer. Alternatively, UE may also be a roadside device, such as a streetlight, a signal light, or other roadside device with wireless communication functions.

In an embodiment of this disclosure, the configuration mode includes at least one of a full configuration mode and a delta configuration mode.

It should be noted that in 4G and 5G systems, the network-side device provides the terminal device with RRC configuration information for configuring the air interface communication of the terminal. The RRC configuration information can be configured in two modes: full configuration and delta configuration. The full configuration mode means, upon receiving a new RRC configuration message in the full configuration mode, clearing the current radio configuration (e.g., dedicated radio configuration and general radio configuration), and then applying the RRC configuration message in the full configuration mode. The delta configuration mode means, upon receiving a new RRC configuration message in the delta configuration mode, applying the configuration in the RRC configuration message in the delta configuration mode based on the current radio configuration. The “current radio configuration” is considered as the “reference configuration” for the “delta configuration”. (For example, a value of “field-1” in the current radio configuration is “1”, a value of “field-2” therein is “1”, and a value of “field-1” in the delta configuration is “2”; after receiving the delta configuration, the value of “field-1″ is set to “2” and the value of “field-2” remains as “1”).

To sum up, according to the method, apparatus, device and storage medium for managing configuration proposed by this disclosure, the terminal device can receive the configuration information of one or more candidate cells or cell groups and the configuration mode corresponding to the configuration information of at least part of the one or more candidate cells or cell groups, and perform configuration according to the configuration mode corresponding to the configuration information of one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

FIG. 5 is a schematic flowchart of a configuration management method according to an embodiment of this disclosure. The method is performed by a terminal device. When the configuration mode is the delta configuration mode, as shown in FIG. 5, the method may include the following steps.

In step 501, configuration information of one or more candidate cells or cell groups, and a configuration mode corresponding to configuration information of at least part of the one or more candidate cells or cell groups, are received.

In step 502, when the configuration mode is the delta configuration mode, the terminal device is configured according to the reference configuration information corresponding to the delta configuration mode and the configuration information.

The reference configuration information may be configuration information of a specific cell or a specific cell group.

Further, in an embodiment of this disclosure, the reference configuration information may include any of the following:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

Further, in an embodiment of this disclosure, a type of the candidate cell or cell group after activation is determined according to network configuration or protocol agreement.

For example, when the delta configuration mode is adopted, the reference configuration information corresponding to the delta configuration mode, that is, the configuration information of the candidate cell or candidate cell group is the delta configuration information relative to which reference configuration information, can be determined through network configuration or protocol agreement. Herein, the reference configuration information may include any of the following types.

As to reference configuration information 1, for specific “configuration information of a candidate cell or cell group” in the delta configuration mode, the “reference configuration information” is “configuration information of a cell or cell group” designated by the network-side device. For example, “candidate cell group configuration-1” is the “delta configuration information” of “candidate cell group configuration-2”, and “candidate cell group configuration-2”is the “reference configuration information” of “candidate cell group configuration-1”. For example, “candidate cell group configuration-1” is the “delta configuration information” of “configuration information of a currently serving (or activated) MCG (or SCG)”, and the “configuration information of the currently serving (or activated) MCG (or SCG)” is the “reference configuration information” of “candidate cell group configuration-1”.

As to reference configuration information 2, for specific “configuration information of a candidate cell or cell group” in the delta configuration mode, “configuration information of a currently serving (or activated) cell or cell group” having a same type as a “candidate cell or cell group type” when it is activated serves as the “reference configuration information” thereof. For example, “candidate cell group configuration-1” is in the “delta configuration mode”, and “candidate cell group configuration-1” is MCG (or SCG) after activation; when the terminal device triggers the activation of “candidate cell group configuration-1” (e.g., when an activation command issued by the network side is received), the “configuration information of a currently serving (or activated) MCG (or SCG)” is the “reference configuration information” of “candidate cell group configuration-1”.

As to reference configuration information 3, for a specific “configuration information of a candidate cell or cell group” in the delta configuration mode, “configuration information of a currently serving (or activated) cell or cell group” having a same type as a “candidate cell or cell group type” when it is activated for the first time serves as the “reference configuration information” thereof. For example, “candidate cell group configuration-1” is in the “delta configuration mode”, and “candidate cell group configuration-1” is MCG (or SCG) after activation; after the terminal device receives “candidate cell group configuration-1”, when the terminal triggers the activation of “candidate cell group configuration-1” for the first time (e.g., when it receives a command to activate “candidate cell group configuration-1” issued by the network side for the first time), then the “configuration information of a currently serving (or activated) MCG (or SCG)” is the “reference configuration information” of “candidate cell group configuration-1”

As to reference configuration information 4, for a specific “configuration information of a candidate cell or cell group” sent in the delta configuration, “configuration information of a serving (or activated) cell or cell group”, upon receiving the “configuration information of a candidate cell or cell group”, having a same type as a “cell or cell group type” after activation, serves as the “reference configuration information” thereof. For example, “candidate cell group configuration-1” is in the “delta configuration mode”, “candidate cell group configuration-1” is MCG (or SCG) after activation, and a sending (or receiving) timepoint of “candidate cell group configuration-1” is t1, then “configuration information of a serving (or activated) MCG (or SCG) at t1” is the “reference configuration information” of “candidate cell group configuration-1”.

Further, in an embodiment of this disclosure, the type of the candidate cell after activation is any one of a primary cell, a primary secondary cell, a special cell, a secondary cell, a secondary cell in a master cell group, and a secondary cell in a secondary cell group.

Further, in an embodiment of this disclosure, the type of the candidate cell group after activation is a master cell group or a secondary cell group.

It should be noted that due to the adoption of DC architecture in the 5G system, it includes the following two cell groups:
MCG: corresponding to the network-side MN;
SCG: corresponding to the network-side SN.

Herein, MCG may include a PCell and one or more SCells; SCG may include a PSCell and one or more SCells, where PCell and PSCell may be collectively referred to as SpCell.

To sum up, according to the method, apparatus, device and storage medium for managing configuration proposed by this disclosure, the terminal device can perform configuration according to the configuration information of one or more candidate cells or cell groups and the reference configuration information corresponding to the delta configuration mode. Thus, the configuration behavior of the terminal device and the network-side device can be stipulated, thereby enabling the terminal device to perform terminal configuration according to the configuration mode corresponding to the configuration information of the preconfigured cell or cell group.

FIG. 6 is a schematic flowchart of a configuration management method according to an embodiment of this disclosure. The method is performed by a terminal device. As shown in FIG. 6, the method may include the following steps.

In step 601, configuration information of one or more candidate cells or cell groups, and a configuration mode corresponding to configuration information of at least part of the one or more candidate cells or cell groups, are received.

In step 602, the terminal device is configured according to the configuration mode corresponding to the configuration information of one or more candidate cells or cell groups.

In step 603, the configuration information of one or more candidate cells or cell groups is stored according to the configuration mode.

For example, the terminal device can store the “configuration information of the candidate cell or cell group” depending on different “configuration modes”. For example, the “configuration information of the candidate cell or cell group” may be stored before activating the configuration information or after deactivating the configuration information. When a candidate cell or cell group is activated, the stored configuration information of the candidate cell or cell group may be directly applied.

To sum up, according to the method, apparatus, device and storage medium for managing configuration proposed by this disclosure, the terminal device can perform configuration according to the configuration information of one or more candidate cells or cell groups and the reference configuration information corresponding to the delta configuration mode. Thus, the configuration behavior of the terminal device and the network-side device can be stipulated, thereby enabling the terminal device to perform terminal configuration according to the configuration mode corresponding to the configuration information of the preconfigured cell or cell group.

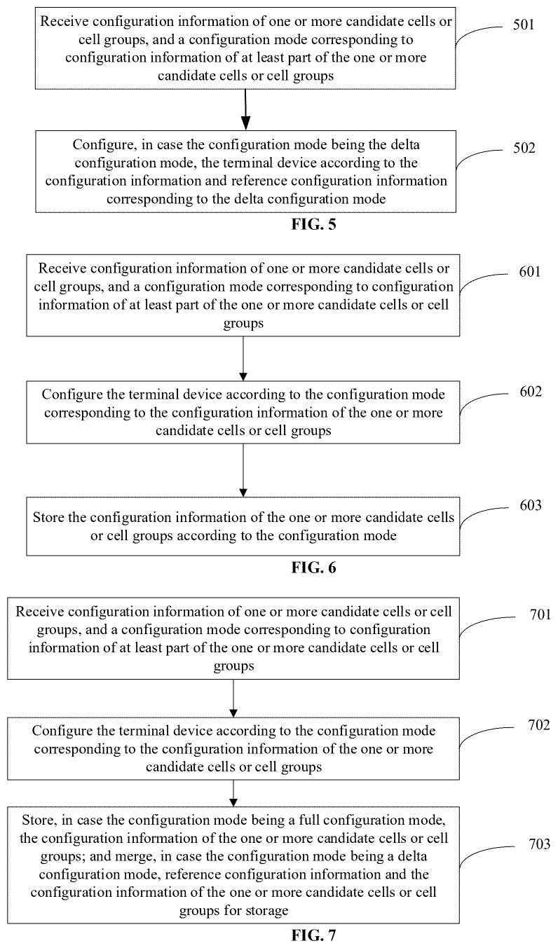

FIG. 7 is a schematic flowchart of a configuration management method according to an embodiment of this disclosure. The method is performed by a terminal device. As shown in FIG. 7, the method may include the following steps.

In step 701, configuration information of one or more candidate cells or cell groups, and a configuration mode corresponding to configuration information of at least part of the one or more candidate cells or cell groups, are received.

In step 702, the terminal device is configured according to the configuration mode corresponding to the configuration information of one or more candidate cells or cell groups.

In step 703, when the configuration mode is the full configuration mode, the configuration information of one or more candidate cells or cell groups is stored; and when the configuration mode is the delta configuration mode, reference configuration information and the configuration information of one or more candidate cells or candidate cells are merged for storage.

For example, the terminal device can store the “configuration information of the candidate cell or cell group” depending on different “configuration modes”. For example, the “configuration information of the candidate cell or cell group” may be stored before activating the configuration information or after deactivating the configuration information. In some embodiments, the storage manners can include any of the followings.

In a storage manner 1, if the configuration mode of the “configuration information of a candidate cell or cell group” is “full configuration mode”, the terminal device stores the “configuration information of the candidate cell or cell group” as received. For example, the terminal device receives “candidate cell group configuration-1” through an RRC message at timepoint t1, and the “candidate cell group configuration-1” is sent in “full configuration mode”, then the terminal device stores “candidate cell group configuration-1” received at timepoint t1. When the candidate cell group is activated, the terminal device applies the “candidate cell group configuration-1” received at timepoint t1.

In a storage manner 2, if the configuration mode of the “configuration information of a candidate cell or cell group” is “delta configuration mode”, the terminal device stores the “configuration information of the candidate cell or cell group” as received and “reference configuration information” corresponding to the “configuration information of the candidate cell or cell group” as received. For example, the terminal device receives the “candidate cell group configuration-1” through an RRC message at timepoint t1, the “candidate cell group configuration-1” is sent in “delta configuration mode”, the “candidate cell group configuration-1” is MCG (or SCG) after activation, and the “reference configuration information” of “candidate cell group configuration-1” is “configuration information of a currently serving (or activated) MCG (or SCG)”. Then, the terminal device stores the “candidate cell group configuration-1” received at timepoint t1″ and the “configuration information of the currently serving (or activated) MCG (or SCG)”. When the candidate cell group is activated, the terminal merges the “candidate cell group configuration-1” received at timepoint t1 and the “configuration information of the currently serving (or activated) MCG (or SCG)”, and then applies the merged configuration information as the configuration information of the activated cell group.

In a storage manner 3, if the configuration mode of the “configuration information of a candidate cell or cell group” is “delta configuration mode”, the terminal device merges the “configuration information of the candidate cell or cell group” as received and “reference configuration information” corresponding to the “configuration information of the candidate cell or cell group” as received, and stores the merged configuration information. For example, the terminal device receives “candidate cell group configuration-1” through an RRC message at timepoint t1, the “candidate cell group configuration-1” is sent in “delta configuration mode”, the “candidate cell group configuration-1” is MCG (or SCG) after activation, and the “reference configuration information” of “candidate cell group configuration-1” is “configuration information of a currently serving (or activated) MCG (or SCG)”. Then, the terminal device merges “the “candidate cell group configuration-1” received at timepoint t1” and the “configuration information of the currently serving (or activated) MCG (or SCG)”, and stores the merged configuration information. When the candidate cell group is activated, the terminal uses the stored merged configuration information as the configuration information of the activated cell group.

Herein, for “storage manner 2”, when the “candidate cell or cell group” is activated, the terminal device merges the “configuration information of the candidate cell or cell group” as received and the “reference configuration information” corresponding to the “configuration information of the candidate cell or cell group” as received, and then applies the merged configuration information as the configuration information of the activated cell (or cell group).

To sum up, according to the method, apparatus, device and storage medium for managing configuration proposed by this disclosure, the terminal device can perform configuration according to the configuration information of one or more candidate cells or cell groups and the reference configuration information corresponding to the delta configuration mode. Thus, the configuration behavior of the terminal device and the network-side device can be stipulated, thereby enabling the terminal device to perform terminal configuration according to the configuration mode corresponding to the configuration information of the preconfigured cell or cell group.

FIG. 8 is a schematic flowchart of a configuration management method according to an embodiment of this disclosure. The method is performed by a source node. As shown in FIG. 8, the method may include the following steps.

In step 801, reference configuration information is determined.

In step 802, the reference configuration information is sent to a target node.

For example, the source node may be a node that currently provides services to the UE or a node that provided services to the UE, for example, a base station that currently provides services to the UE or a base station that provided services to the UE. The target node may be a node other than the source node, for example, a base station other than the source node. The source node may be configured to send reference configuration information to the target node; and the target node may be configured to send configuration information of a candidate cell or cell group to the source node, and indicate a configuration mode corresponding to the configuration information of the candidate cell or cell group. The network-side device in the forgoing embodiments may be a source node or a target node.

In an embodiment of this disclosure, the reference configuration information is configuration information of a specific cell or a specific cell group.

It should be noted that the reference configuration information can be stipulated through network configuration or protocol agreement, that is, it is stipulated through network configuration or protocol agreement which reference configuration information the configuration information of the candidate cell or cell group is the delta configuration information for.

By way of example, in an embodiment of this disclosure, the reference configuration information may include at least one of the following:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

It should be noted that specific examples of the reference configuration information may be as described in the forgoing embodiments, which will not be repeated here.

To sum up, according to the method, apparatus, device and storage medium for managing configuration proposed by this disclosure, the source node can determine the reference configuration information and send the reference configuration information to the target node. Thus, negotiation between network nodes can be implemented on the reference configuration information, thereby stipulating the configuration behavior of the terminal device and the network-side device and, thus, enabling the terminal device to perform terminal configuration according to the configuration mode corresponding to the configuration information of the preconfigured cell or cell group.

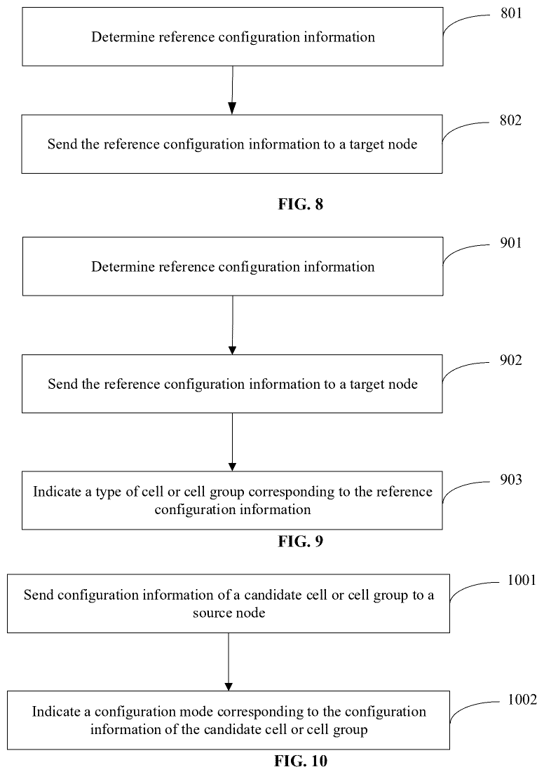

FIG. 9 is a schematic flowchart of a configuration management method according to an embodiment of this disclosure. The method is performed by a source node. As shown in FIG. 9, the method may include the following steps.

In step 901, reference configuration information is determined.

In step 902, the reference configuration information is sent to a target node.

In step 903, a type of cell or cell group corresponding to the reference configuration information is indicated.

Further, in an embodiment of this disclosure, the type of cell or cell group corresponding to the reference configuration information is the same as a type of a candidate cell or cell group.

It should be noted that the type of cell or cell group corresponding to the reference configuration information is the same as a type of a cell or cell group corresponding to the configuration information of the candidate cell or cell group that needs to be obtained. For example, if the “reference configuration information” is “configuration information of the currently serving (or activated) MCG (or SCG)”, then the candidate cell group is the MCG (or SCG).

Further, in an embodiment of this disclosure, the type of cell is any one of a primary cell, a primary secondary cell, a special cell, a secondary cell, a secondary cell in a master cell group, and a secondary cell in a secondary cell group.

Further, in an embodiment of this disclosure, the type of cell group is a master cell group or a secondary cell group.

As an example, the DC architecture is adopted in the 5G system, and the following two cell groups are included:
MCG: corresponding to the network-side MN;
SCG: corresponding to the network-side SN.

Herein, MCG may include a PCell and one or more SCells; SCG may include a PSCell and one or more SCells, where PCell and PSCell may be collectively referred to as SpCell.

To sum up, according to the method, apparatus, device and storage medium for managing configuration proposed by this disclosure, the source node can determine the reference configuration information, send the reference configuration information to the target node, and indicate the type of cell or cell group corresponding to the reference configuration information. Thus, negotiation between network nodes can be implemented on the reference configuration information, thereby stipulating the configuration behavior of the terminal device and the network-side device and, thus, enabling the terminal device to perform terminal configuration according to the configuration mode corresponding to the configuration information of the preconfigured cell or cell group.

FIG. 10 is a schematic flowchart of a configuration management method according to an embodiment of this disclosure. The method is performed by a target node. As shown in FIG. 10, the method may include the following steps.

In step 1001, configuration information of a candidate cell or cell group is sent to a source node.

In step 1002, a configuration mode corresponding to the configuration information of the candidate cell or cell group is indicated.

For example, the target node may be a node other than the source node, for example, a base station other than the source node. The source node may be configured to send reference configuration information to the target node; and the target node may be configured to send configuration information of the candidate cell or cell group to the source node, and indicate the configuration mode corresponding to the configuration information of the candidate cell or cell group. The network-side device in the forgoing embodiments may be a source node or a target node.

Moreover, in an embodiment of this disclosure, the configuration mode may include at least one of a full configuration mode and a delta configuration mode.

It should be noted that in 4G and 5G systems, the network-side device provides the terminal device with RRC configuration information for configuring the air interface communication of the terminal. The RRC configuration information can be configured in two modes: full configuration and delta configuration.

The full configuration mode means, upon receiving a new RRC configuration message in the full configuration mode, clearing the current radio configuration (e.g., dedicated radio configuration and general radio configuration), and then applying the RRC configuration message in the full configuration mode.

The delta configuration mode means, upon receiving a new RRC configuration message in the delta configuration mode, applying the configuration in the RRC configuration message in the delta configuration mode based on the current radio configuration. The “current radio configuration” is considered as the “reference configuration” for the “delta configuration”. (For example, a value of “field-1” in the current radio configuration is “1”, a value of “field-2” therein is “1”, and a value of “field-1” in the delta configuration is “2”; after receiving the delta configuration, the value of “field-1 “is set to “2” and the value of “field-2” remains as “1”).

To sum up, according to the method, apparatus, device and storage medium for managing configuration proposed by this disclosure, the target node sends the configuration information of the candidate cell or cell group to the source node, and indicate the configuration mode corresponding to the configuration information of the candidate cell or cell group. Thus, negotiation between network nodes can be implemented on the configuration mode corresponding to the configuration information of the candidate cell or cell group, thereby stipulating the configuration behavior of the terminal device and the network-side device and, thus, enabling the terminal device to perform terminal configuration according to the configuration mode corresponding to the configuration information of the preconfigured cell or cell group.

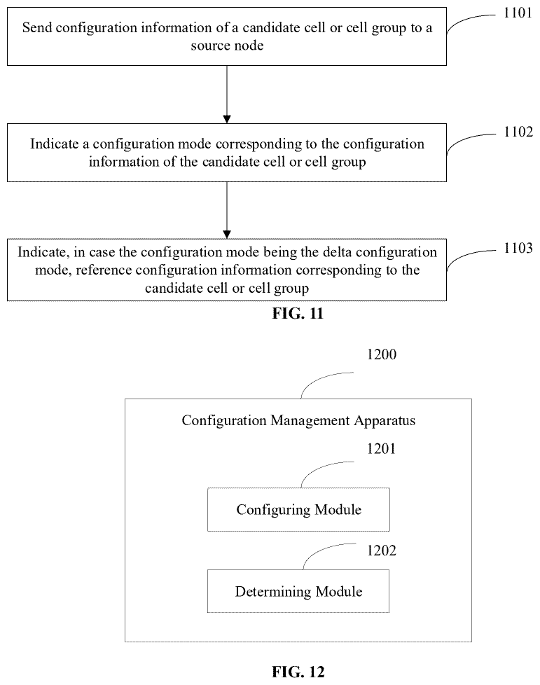

FIG. 11 is a schematic flowchart of a configuration management method according to an embodiment of this disclosure. The method is performed by a target node. As shown in FIG. 11, the method may include the following steps.

In step 1101, configuration information of a candidate cell or cell group is sent to a source node.

In step 1102, a configuration mode corresponding to the configuration information of the candidate cell or cell group is indicated.

In step 1103, when the configuration mode is the delta configuration mode, reference configuration information corresponding to the candidate cell or cell group is indicated.

It should be noted that when the configuration mode is “delta configuration mode”, the target node indicates the “reference configuration information” adopted by the “candidate cell or cell group sending configuration information”. For example, the “reference configuration information” corresponding to the “configuration information of the candidate cell or cell group” is indicated through a configuration identifier, where the configuration identifier may be a configuration identifier of the “reference configuration information” provided by the source node to the target node.

To sum up, according to the method, apparatus, device and storage medium for managing configuration proposed by this disclosure, the target node sends the configuration information of the candidate cell or cell group to the source node, and indicate the configuration mode corresponding to the configuration information of the candidate cell or cell group. Thus, negotiation between network nodes can be implemented on the configuration mode corresponding to the configuration information of the candidate cell or cell group, thereby stipulating the configuration behavior of the terminal device and the network-side device and, thus, enabling the terminal device to perform terminal configuration according to the configuration mode corresponding to the configuration information of the preconfigured cell or cell group.

FIG. 12 is a schematic structural diagram of a configuration management apparatus according to an embodiment of this disclosure. As shown in FIG. 12, the apparatus 1200 may include:
a configuring module 1201, used to configure one or more candidate cells or cell groups for a terminal device; and
a determining module 1202, used to determine a configuration mode corresponding to configuration information of at least part of the one or more candidate cells or cell groups.

To sum up, according to the method, apparatus, device and storage medium for managing configuration proposed by this disclosure, the network-side device configures one or more candidate cells or cell groups for the terminal device; and determines a configuration mode corresponding to configuration information of at least part of the one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

Optionally, in an embodiment of this disclosure, the configuration mode includes at least one of a full configuration mode and a delta configuration mode.

Optionally, in an embodiment of this disclosure, the apparatus 1200 is further configured to:

determine, in case the configuration mode being the delta configuration mode, reference configuration information corresponding to the delta configuration mode, where the reference configuration information is configuration information of a specific cell or a specific cell group.

Optionally, in an embodiment of this disclosure, the reference configuration information includes any of the following:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

Optionally, in an embodiment of this disclosure, a type of the candidate cell or cell group after activation is determined according to network configuration or protocol agreement.

Optionally, in an embodiment of this disclosure, the type of the candidate cell after activation is any one of a primary cell, a primary secondary cell, a special cell, a secondary cell, a secondary cell in a master cell group, and a secondary cell in a secondary cell group.

Optionally, in an embodiment of this disclosure, the type of the candidate cell group after activation is a master cell group or a secondary cell group.

Optionally, in an embodiment of this disclosure, the determining module 1202 is specifically configured to:
indicate that the configuration mode corresponding to the configuration information of the at least part of the one or more candidate cells or cell groups is the full configuration mode or the delta configuration mode; or
indicate that the configuration mode corresponding to the configuration information of the at least part of the one or more candidate cells or cell groups is not the full configuration mode or is not the delta configuration mode.

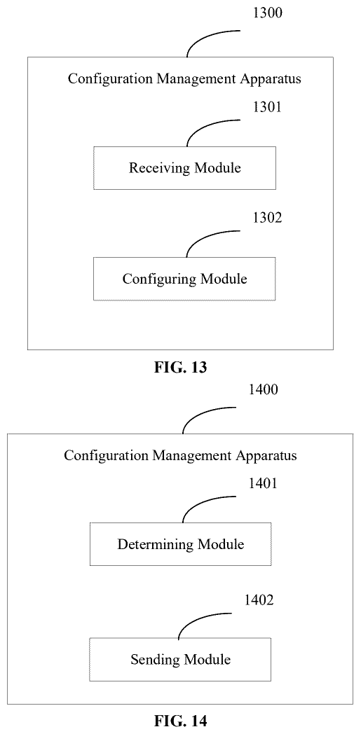

FIG. 13 is a schematic structural diagram of a configuration management apparatus according to an embodiment of this disclosure. As shown in FIG. 13, the device 1300 may include: a receiving module 1301, configured to receive configuration information of one or more candidate cells or cell groups, and a configuration mode corresponding to configuration information of at least part of the one or more candidate cells or cell groups; and
a configuring module 1302, used to configure the terminal device according to the configuration mode corresponding to the configuration information of the one or more candidate cells or cell groups.

To sum up, according to the method, apparatus, device and storage medium for managing configuration proposed by this disclosure, the terminal device can receive the configuration information of one or more candidate cells or cell groups and the configuration mode corresponding to the configuration information of at least part of the one or more candidate cells or cell groups, and perform configuration according to the configuration mode corresponding to the configuration information of one or more candidate cells or cell groups. Thus, the configuration behavior of the terminal device and the network-side device can be stipulated, thereby enabling the terminal device to perform terminal configuration according to the configuration mode corresponding to the configuration information of the preconfigured cell or cell group.

Optionally, in an embodiment of this disclosure, the configuration mode includes at least one of a full configuration mode and a delta configuration mode.

Optionally, in an embodiment of this disclosure, the configuring module 1302 is specifically used to:
configure the terminal device according to the configuration information and reference configuration information corresponding to the delta configuration mode, where the reference configuration information is configuration information of a specific cell or a specific cell group.

Optionally, in an embodiment of this disclosure, the reference configuration information includes any one of:
configuration information of a designated cell or a designated cell group;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time;
configuration information of a cell or cell group having a same type as the candidate cell or cell group after activation, and being in a service state or an activated state at a receiving timepoint or a sending timepoint of configuration information of the candidate cell or cell group.

Optionally, in an embodiment of this disclosure, a type of the candidate cell or cell group after activation is determined according to network configuration or protocol agreement.

Optionally, in an embodiment of this disclosure, the type of the candidate cell after activation is any one of a primary cell, a primary secondary cell, a special cell, a secondary cell, a secondary cell in a master cell group, and a secondary cell in a secondary cell group.

Optionally, in an embodiment of this disclosure, the type of the candidate cell group after activation is a master cell group or a secondary cell group.

Optionally, in an embodiment of this disclosure, the apparatus 1300 is further configured to:

store the configuration information of the one or more candidate cells or cell groups according to the configuration mode.

Optionally, in an embodiment of this disclosure, the apparatus 1300 is further configured to:
store, in case the configuration mode being a full configuration mode, the configuration information of the one or more candidate cells or cell groups; and
merge, in case the configuration mode being a delta configuration mode, reference configuration information and the configuration information of the one or more candidate cells or cell groups for storage.

FIG. 14 is a schematic structural diagram of a configuration management apparatus according to an embodiment of this disclosure. As shown in FIG. 14, the apparatus may include: a determining module 1401, configured to determine reference configuration information; and a sending module 1402, configured to send the reference configuration information to a target node.

To sum up, according to the method, apparatus, device and storage medium for managing configuration proposed by this disclosure, the source node can determine the reference configuration information and send the reference configuration information to the target node. Thus, negotiation between network nodes can be implemented on the reference configuration information, thereby stipulating the configuration behavior of the terminal device and the network-side device and, thus, enabling the terminal device to perform terminal configuration according to the configuration mode corresponding to the configuration information of the preconfigured cell or cell group.

Optionally, in an embodiment of this disclosure, the apparatus is further configured to:

indicate a type of cell or cell group corresponding to the reference configuration information.

Optionally, in an embodiment of this disclosure, the reference configuration information is configuration information of a specific cell or a specific cell group.

Optionally, in an embodiment of this disclosure, the type of cell or cell group corresponding to the reference configuration information is the same as a type of the candidate cell or cell group.

Optionally, in an embodiment of this disclosure, the type of cell is any one of a primary cell, a primary secondary cell, a special cell, a secondary cell, a secondary cell in a master cell group, and a secondary cell in a secondary cell group.

Optionally, in an embodiment of this disclosure, the type of cell group is a master cell group or a secondary cell group.

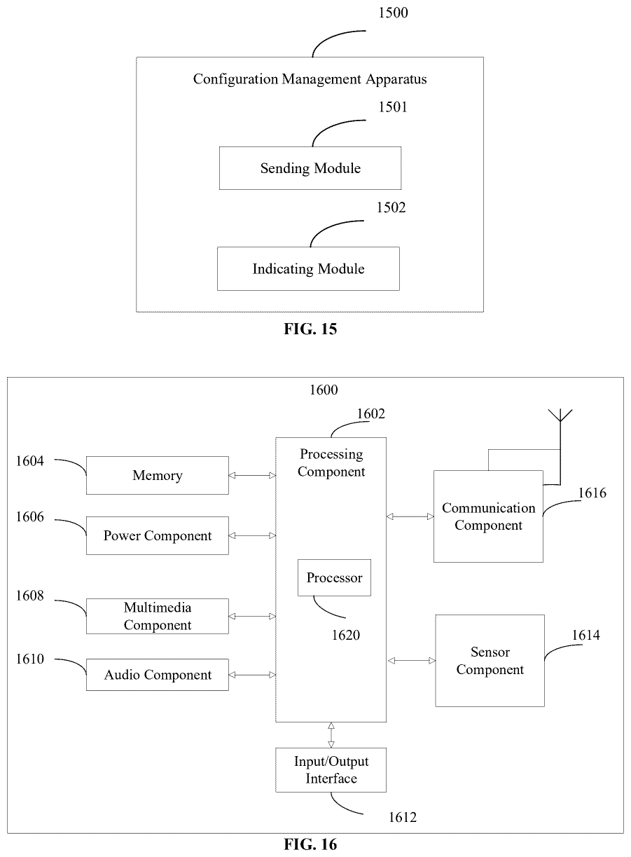

FIG. 15 is a schematic structural diagram of a configuration management apparatus according to an embodiment of this disclosure. As shown in FIG. 15, the apparatus 1500 may include:
a sending module 1501, configured to send configuration information of a candidate cell or cell group to a source node; and
an indication module 1502, configured to indicate a configuration mode corresponding to the configuration information of the candidate cell or cell group.

To sum up, according to the method, apparatus, device and storage medium for managing configuration proposed by this disclosure, the target node sends the configuration information of the candidate cell or cell group to the source node, and indicate the configuration mode corresponding to the configuration information of the candidate cell or cell group. Thus, negotiation between network nodes can be implemented on the configuration mode corresponding to the configuration information of the candidate cell or cell group, thereby stipulating the configuration behavior of the terminal device and the network-side device and, thus, enabling the terminal device to perform terminal configuration according to the configuration mode corresponding to the configuration information of the preconfigured cell or cell group.

Optionally, in an embodiment of this disclosure, the configuration mode includes at least one of a full configuration mode and a delta configuration mode.

Optionally, in an embodiment of this disclosure, the apparatus 1500 is further configured to:

indicate, in case the configuration mode being the delta configuration mode, reference configuration information corresponding to the candidate cell or cell group.

FIG. 16 is a block diagram of a terminal device UE1600 according to an embodiment of this disclosure. For example, the UE 1600 may be a mobile phone, a computer, a digital broadcast terminal, a messaging device, a game console, a tablet device, a medical device, a fitness device, a personal digital assistant, and the like.

Referring to FIG. 16, the UE 1600 may include one or more of the following components: processing component 1602, memory 1604, power component 1606, multimedia component 1608, audio component 1610, input/output (I/O) interface 1612, sensor component 1613, and communication component 1616.

The processing component 1602 generally controls the overall operation of the UE 1600, such as operations associated with display, phone calls, data communications, camera operations, and recording operations. The processing component 1602 may include one or more processors 1620 to execute instructions to perform all or some of the steps of the methods described above. Additionally, the processing component 1602 may include at least one module that facilitates interaction between the processing component 1602 and other components. For example, the processing component 1602 may include a multimedia module to facilitate interaction between the multimedia component 1608 and the processing component 1602.

The memory 1604 is configured to store various types of data to support operations at the UE 1600. Examples of such data include instructions, contact data, phonebook data, messages, pictures, videos, and the like for any application or method operating on the UE 1600. The memory 1604 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 1606 provides power to various components of the UE 1600. The power components 1606 may include a power management system, at least one power source, and other components associated with generating, managing, and distributing power to the UE 1600.

The multimedia component 1608 includes a screen that provides an output interface between the UE 1600 and the user. In some embodiments, the screen may include a liquid crystal display (LCD) and a touch panel (TP). If the screen includes a touch panel, the screen may be implemented as a touch screen to receive input signals from a user. The touch panel includes at least one touch sensor to sense touch, swipe, and gestures on the touch panel. The touch sensor may not only sense the boundaries of a touch or swipe action, but also detect the duration and pressure associated with the touch or swipe action. In some embodiments, the multimedia component 1608 includes a front camera and/or a rear camera. When the UE 1600 is in an operation mode, such as a shooting mode or a video mode, the front camera and/or the rear camera may receive external multimedia data. Each of the front and rear cameras may be a fixed optical lens system or have focal length and optical zoom capability.

The audio component 1610 is configured to output and/or input audio signals. For example, the audio component 1610 includes a microphone (MIC) that is configured to receive external audio signals when the UE 1600 is in operating modes, such as calling mode, recording mode, and voice recognition mode. The received audio signal may be further stored in the memory 1604 or transmitted via the communication component 1616. In some embodiments, the audio component 1610 also includes a speaker for outputting audio signals.

The I/O interface 1612 provides an interface between the processing component 1602 and a peripheral interface module, which may be a keyboard, a click wheel, a button, or the like. These buttons may include, but are not limited to: home button, volume buttons, start button, and lock button.

The sensor assembly 1613 includes at least one sensor for providing status assessments of various aspects of the UE 1600. For example, the sensor assembly 1613 can detect the open/closed state of the UE 1600, the relative positioning of components, such as the display and keypad of the UE 1600. The sensor assembly 1613 can also detect a change in the position of the UE 1600 or a component of the UE 1600, the presence or absence of user contact with the UE 1600, the orientation or acceleration/deceleration of the UE 1600, and the temperature change of the UE 1600. The sensor assembly 1613 may include a proximity sensor configured to detect the presence of nearby objects in the absence of any physical contact. The sensor assembly 1613 may also include a light sensor, such as a CMOS or CCD image sensor, for use in imaging applications. In some embodiments, the sensor assembly 1613 may also include an acceleration sensor, a gyroscope sensor, a magnetic sensor, a pressure sensor, or a temperature sensor.

The communication component 1616 is configured to facilitate wired or wireless communication between the UE 1600 and other devices. The UE 1600 may access wireless networks based on communication standards, such as WiFi, 2G or 3G, or a combination thereof. In some embodiments, the communication component 1616 receives broadcast signals or broadcast related information from an external broadcast management system via a broadcast channel. In some embodiments, the communication component 1616 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the UE 1600 may be implemented by at least one application specific integrated circuit (ASIC), digital signal processor (DSP), digital signal processing device (DSPD), programmable logic device (PLD), field programmable gate array (FPGA), controller, microcontroller, microprocessor or other electronic component, which are configured to perform the forgoing methods.

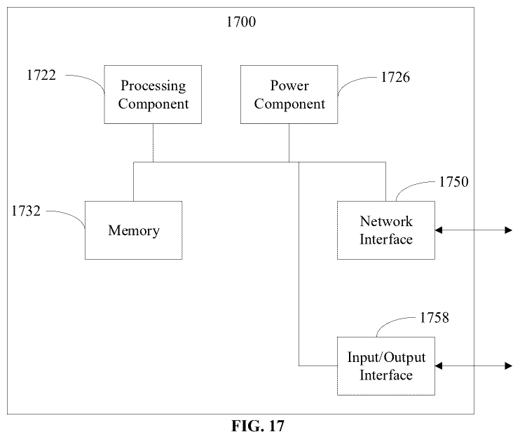

FIG. 17 is a block diagram of a network-side device 1700 according to an embodiment of this disclosure. For example, the network-side device 1700 may be provided as a network-side device. Referring to FIG. 17, the network-side device 1700 includes a processing component 1711, which further includes at least one processor, and a memory resource represented by a memory 1732 for storing instructions, such as application programs, that can be executed by the processing component 1722. Application programs stored in memory 1732 may include one or more modules, each corresponding to a set of instructions. In addition, the processing component 1712 is configured to execute instructions to perform any of the foregoing methods applied to the network-side device, for example, the method shown in FIG. 1.

The network-side device 1700 may also include a power component 1726 configured to perform power management of the network-side device 1700, a wired or wireless network interface 1750 configured to connect the network-side device 1700 to the network, and an input/output (I/O) interface 1758. The network-side device 1700 may operate based on an operating system stored in the memory 1732, such as Windows Server™, Mac OS X™, Unix™, Linux™, FreeBSD™ or the like.

In the above-mentioned embodiments of this disclosure, the methods according to some embodiments of this disclosure are described from the perspectives of network-side device, terminal device, source node, and target node, respectively. In order to implement each function in the method according to the above embodiments of this disclosure, the network-side device, terminal device, source node, and target node may include hardware structures, software modules and implement the above functions in the form of hardware structures, software modules, or hardware structures plus software modules. A specific function among the above functions can be executed by a hardware structure, a software module, or a hardware structure plus a software module.

In the above-mentioned embodiments of this disclosure, the methods according to some embodiments of this disclosure are described from the perspectives of network-side device, terminal device, source node, and target node, respectively. In order to implement each function in the method according to the above embodiments of this disclosure, the network-side device, terminal device, source node, and target node may include hardware structures, software modules and implement the above functions in the form of hardware structures, software modules, or hardware structures plus software modules. A specific function among the above functions can be executed by a hardware structure, a software module, or a hardware structure plus a software module.

A communication device is provided according to an embodiment of this disclosure. The communication device may include a transceiving module and a processing module. The transceiving module may include a sending module and/or a receiving module. The sending module is configured to implement the sending function, and the receiving module is configured to implement the receiving function. The transceiving module may implement the sending function and/or the receiving function.

The communication device may be a terminal device (e.g., the terminal device in the foregoing method embodiments), an apparatus in the terminal device, or an apparatus that can be used in conjunction with the terminal device. Alternatively, the communication device may be a network-side device, an apparatus in the network-side device, or an apparatus that can be used in conjunction with the network-side device. Alternatively, the communication device may be a source node, an apparatus in the source node, or an apparatus that can be used in conjunction with the source node. Alternatively, the communication device may be a target node, an apparatus in the target node, or an apparatus that can be used in conjunction with the target node.

Another communication device is provided according to an embodiment of this disclosure. The communication device may be a network-side device; a terminal device (e.g., the terminal device in the foregoing method embodiments); a source node; a target node; a chip, a chip system, a processor, or the like that supports the network-side device to implement the above method; a chip, a chip system, a processor, or the like that supports the terminal device to implement the above method; a chip, a chip system, a processor, or the like that supports the source node to implement the above method; or a chip, a chip system, a processor, or the like that supports the target node to implement the above method. The device can be used to implement the method described in the above method embodiments. For details, the description in the above method embodiments may be referred to.

The communications device may include one or more processors. The processor may be a general-purpose processor, a special-purpose processor, or the like. For example, it may be a baseband processor or a central processing unit. The baseband processor can be used to process communication protocols and communication data, and the central processing unit can be used to control communication devices (e.g., network-side device, baseband chip, terminal device, terminal device chip, DU, CU, or the like), execute a computer program, and process data for the computer program.

Optionally, the communication device may also include one or more memories, on which a computer program may be stored. The processor executes the computer program, thereby causing the communication device to implement the method described in the above method embodiments. Optionally, data may also be stored in the memory. The communication device and the memory can be provided separately or integrated together.

Optionally, the communication device may also include a transceiver and an antenna. The transceiver can be called a transceiver unit, a transceiver, a transceiver circuit, or the like, and is used to implement transceiving functions. The transceiver may include a receiver and a transmitter. The receiver can be called a receiver, a receiving circuit, or the like, and is used to implement the receiving function. The transmitter can be called a transmitter, a transmitting circuit, or the like, and is used to implement the transmitting function.

Optionally, the communication device may also include one or more interface circuits. The interface circuit is used to receive code instructions and transmit them to the processor. The processor executes the code instructions to cause the communication device to implement the method described in the above method embodiments.

When the communication device is a network-side device, the processor is configured to implement the method shown in any one of FIG. 1 to FIG. 3.

When the communication device is a terminal device (e.g., the terminal device in the foregoing method embodiments), the processor is configured to implement the method shown in any one of FIG. 4 to FIG. 7.

When the communication device is a source node (e.g., the source node in the foregoing method embodiments), the transceiver is configured to implement the method shown in any one of FIG. 8 to FIG. 9.

When the communication device is a target node (e.g., the target node in the foregoing method embodiments), the processor is configured to implement the method shown in any one of FIG. 10 to FIG. 11.

As an implementation, a transceiver for implementing receiving and transmitting functions may be included in the processor. For example, the transceiver may be a transceiving circuit, an interface, or an interface circuit. The transceiving circuit, interface or interface circuit configured to implement the receiving and transmitting functions may be separate or integrated together. The above-mentioned transceiving circuit, interface or interface circuit may be used for reading and writing codes/data. Alternatively, the above-mentioned transceiving circuit, interface or interface circuit can be used for signal transmission or transfer.

As an implementation, the processor may store a computer program, and the computer program runs on the processor, thereby causing the communication device to implement the method described in the above method embodiments. The computer program may be embedded in the processor, in which case the processor may be implemented in hardware.

As an implementation, the communication device may include a circuit, and the circuit may implement the functions of sending or receiving or communicating in the foregoing method embodiments. The processors and transceivers described in this disclosure can be implemented in integrated circuits (ICs), analog ICs, radio frequency integrated circuits (RFICs), mixed signal ICs, ASICs, printed circuit boards (PCBs), electronic devices, or the like. The processor and transceiver can also be manufactured using various IC process technologies, such as complementary metal oxide semiconductor (CMOS), n-type metal oxide semiconductor (NMOS), p-type metal oxide semiconductor (PMOS), bipolar junction transistor (BJT), bipolar CMOS (BiCMOS), silicon germanium (SiGe), gallium arsenide (GaAs), or the like.

The communication device described in the above embodiments may be a network-side device or a terminal device (e.g., the terminal device in the foregoing method embodiments) or a source node or a target node, but the scope of the communication device described in this disclosure is not limited thereto. The structure of the communication device is neither limited. The communication device may be a stand-alone device or may be part of a larger device. For example, the communication device may be:
(1) independent IC, or chip, or chip system or subsystem;
(2) a collection of one or more ICs; optionally, the IC collection may also include storage components for storing data and computer programs;
(3) ASIC, such as modem;
(4) modules that can be embedded in other devices;
(5) receiver, terminal device, intelligent terminal device, cellular phone, wireless device, handheld device, mobile unit, vehicle-mounted device, network device, cloud device, artificial intelligence device, or the like;
(6) and the like.

Where the communication device may be a chip or a chip system, the chip includes a processor and an interface. The number of processors may be one or more, and the number of interfaces may be multiple.

Optionally, the chip also includes a memory, which is used to store necessary computer programs and data.

Those skilled in the art can also understand that the various illustrative logical blocks and steps listed in the embodiments of this disclosure can be implemented by electronic hardware, computer software, or a combination thereof. Whether such functionality is implemented in hardware or software depends on the specific application and overall system design requirements. Those skilled in the art can use various methods to implement the described functions for each specific application, but such implementation should not be understood as beyond the protection scope of the embodiments of this disclosure.

Embodiments of this disclosure also provide a configuration management system. The system includes a communication device as the terminal device in the forgoing embodiments (e.g., the first terminal device in the forgoing method embodiments), a communication device as the network-side device, a communication device as the source node, and a communication device as the target node. Alternatively, the system includes a communication device as the terminal device in the forgoing embodiments (e.g., the first terminal device in the forgoing method embodiments), a communication device as the network-side device, a communication device as the source node, and a communication device as the target node.

This disclosure also provides a readable storage medium on which instructions are stored, and when the instructions are executed by a computer, the functions of any of the above method embodiments are implemented.

This disclosure also provides a computer program product, which, when executed by a computer, implements the functions of any of the above method embodiments.

The above embodiments may be implemented in whole or in part by software, hardware, firmware, or any combination thereof. When implemented using software, it may be implemented in whole or in part in the form of a computer program product. The computer program product includes one or more computer programs. When the computer program is loaded and executed on a computer, the processes or functions described in accordance with the embodiments of this disclosure are implemented in whole or in part. The computer may be a general-purpose computer, a special-purpose computer, a computer network, or other programmable device. The computer program may be stored in or transferred from one computer-readable storage medium to another, for example, the computer program may be transferred from a website, computer, server, or data center to another website, computer, server or data center through wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server, data center, or the like that contains one or more available integrated medium. The available medium may be magnetic medium (e.g., floppy disks, hard disks, magnetic tapes), optical medium (e.g., high-density digital video discs (DVD)), or semiconductor medium (e.g., solid state disks, SSD)) and the like.

Those of ordinary skill in the art can understand that the first, second, and other numerical numbers involved in this disclosure are only for convenience of description and are not directed to limit the scope of the embodiments of the disclosure, nor to indicate the order.

“At least one” in this disclosure can also be described as one or more, and the plurality can be two, three, four or more, which are not limited in this disclosure. In some embodiments of this disclosure, for a type of technical feature, a specific technical feature may be distinguished by “first”, “second”, “third”, “A”, “B”, “C”, “D” and the like. The technical features described as “first”, “second”, “third”, “A”, “B”, “C” and “D” are in no particular sequence or size order.

Other embodiments of the invention will be readily apparent to those skilled in the art from consideration of the specification and practice of the invention disclosed herein. This disclosure is intended to cover any variations, uses, or adaptations of the invention that follow the general principles of the invention and include common sense or customary technical means in the art that are not disclosed in this disclosure. It is intended that the specification and examples be considered as exemplary only, with a true scope and spirit of the disclosure being indicated by the following claims.

It is to be understood that this disclosure is not limited to the precise structures described above and illustrated in the accompanying drawings, and various modifications and changes may be made without departing from the scope thereof. The scope of the disclosure is limited only by the appended claims.

1. A configuration management method, being performed by a network-side device and comprising:
configuring one or more candidate cells or cell groups for a terminal device; and
determining a configuration mode corresponding to configuration information of at least part of candidate cell or part of candidate cell group among the one or more candidate cells or cell groups.

2. The configuration management method according to claim 1, wherein the configuration mode comprises at least one of a full configuration mode or a delta configuration mode.

3. The configuration management method according to claim 2, further comprising:
determining, in response to the configuration mode being the delta configuration mode, reference configuration information corresponding to the delta configuration mode, wherein the reference configuration information is configuration information of a specific cell or a specific cell group.

4. The configuration management method according to claim 3, wherein the reference configuration information comprises any one of:
configuration information of a designated cell or a designated cell group;
configuration information of a cell or cell group having a same type as the candidate cell or cell group after activation and being in a service state or an activated state;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time; or
configuration information of a cell or cell group having a same type as the candidate cell or cell group after activation, and being in a service state or an activated state at a receiving timepoint or a sending timepoint of configuration information of the candidate cell or cell group.

5. The configuration management method according to claim 4, wherein a type of the candidate cell or cell group after activation is determined according to network configuration or protocol agreement.

6. The configuration management method according to claim 4, wherein the type of the candidate cell after activation is any one of a primary cell, a primary secondary cell, a special cell, a secondary cell, a secondary cell in a master cell group, or a secondary cell in a secondary cell group.

7. The configuration management method according to claim 4, wherein the type of the candidate cell group after activation is the master cell group or the secondary cell group.

8. The configuration management method according to claim 2, wherein determining the configuration mode corresponding to the configuration information of the at least part of candidate cell or part of candidate cell group among the one or more candidate cells or cell groups comprises:
indicating that the configuration mode corresponding to the configuration information of the at least part of candidate cell or part of candidate cell group among the one or more candidate cells or cell groups is the full configuration mode or the delta configuration mode; or
indicating that the configuration mode corresponding to the configuration information of the at least part of candidate cell or part of candidate cell group among the one or more candidate cells or cell groups is not the full configuration mode or is not the delta configuration mode.

9. A configuration management method, being performed by a terminal device and comprising:
receiving configuration information of one or more candidate cells or cell groups, and a configuration mode corresponding to configuration information of at least part of candidate cell or part of candidate cell group among the one or more candidate cells or cell groups; and
performing configuration according to the configuration mode corresponding to the configuration information of the one or more candidate cells or cell groups.

10. The configuration management method according to claim 9, wherein the configuration mode comprises at least one of a full configuration mode or a delta configuration mode.

11. The configuration management method according to claim 10, wherein performing the configuration according to the configuration mode corresponding to the configuration information of the one or more candidate cells or cell groups comprises:
performing the configuration, in response to the configuration mode being the delta configuration mode, according to the configuration information and reference configuration information corresponding to the delta configuration mode, wherein the reference configuration information is configuration information of a specific cell or a specific cell group.

12. The configuration management method according to claim 11, wherein the reference configuration information comprises any one of:
configuration information of a designated cell or a designated cell group;
configuration information of a cell or cell group having a same type as the candidate cell or cell group after activation and being in a service state or an activated state;
configuration information of a cell or cell group having a same type as the candidate cell or cell group after activation, and being in a service state or an activated state when the candidate cell or cell group is activated;
configuration information of a cell or cell group having a same type as the candidate cell or cell group after activation, and being in a service state or an activated state when the candidate cell or cell group is activated for the first time; or
configuration information of a cell or cell group having a same type as the candidate cell or cell group after activation, and being in a service state or an activated state at a receiving timepoint or a sending timepoint of configuration information of the candidate cell or cell group.

13. The configuration management method according to claim 12, wherein a type of the candidate cell or cell group after activation is determined according to network configuration or protocol agreement.

14. The configuration management method according to claim 12, wherein the type of the candidate cell after activation is any one of a primary cell, a primary secondary cell, a special cell, a secondary cell, a secondary cell in a master cell group, or a secondary cell in a secondary cell group.

15. The configuration management method according to claim 12, wherein the type of the candidate cell group after activation is the master cell group or the secondary cell group.

16. The configuration management method according to claim 9, further comprising:
storing the configuration information of the one or more candidate cells or cell groups according to the configuration mode.

17. The configuration management method according to claim 16, wherein storing the configuration information of the one or more candidate cells or cell groups according to the configuration mode comprises:
storing, in response to the configuration mode being a full configuration mode, the configuration information of the one or more candidate cells or cell groups; and
merging, in response to the configuration mode being a delta configuration mode, reference configuration information and the configuration information of the one or more candidate cells or cell groups for storage.

18-30. (canceled)

31. A network-side device, in comprising a processor and a memory, wherein the memory stores a computer program, and the processor is configured to, upon executing the computer program stored in the memory, causes the device to:
configuring one or more candidate cells or cell groups for a terminal device; and
determining a configuration mode corresponding to configuration information of at least part of candidate cell or part of candidate cell group among the one or more candidate cells or cell groups.

32. A terminal device, characterized in comprising a processor and a memory, wherein the memory stores a computer program, and the processor is configured to, upon executing the computer program stored in the memory, causes the device to implement the method according to claim 9.

33-42. (canceled)
